(19) United States
(12) Patent Application Publication
(10) Pub. No.: US 2005/0210978 A1
(43) Pub. Date: Sep. 29, 2005

(54) Sensor having integrated actuation and detection means

(76) Inventors: Markus Lang, Reutlingen (DE); Arnd Gangei, Eningen (DE); Gerhard Wucher, Reutlingen (DE)

Correspondence Address: KENYON & KENYON, ONE BROADWAY, NEW YORK, NY, 10004, US

(21) Appl. No.: 11/042,454

(22) Filed: Jan. 25, 2005

(30) Foreign Application Priority Data
Mar. 27, 2004 (DE) 102004015122.9

(51) Int. Cl. G01P 3/44

(52) U.S. Cl. 73/504.12; 340/669

(57) ABSTRACT

A sensor having at least one actuation/detection device, one actuation unit, and one analyzing unit. In a first operating state, the actuation/detection device is connected to the actuation unit and, in a second operating state, the actuation/detection device is connected to the analyzing unit.

### FIELD OF THE INVENTION

The present invention is directed to a sensor having at least one actuation/detection means, one actuation unit, and one analyzing unit.

### BACKGROUND INFORMATION

Actively oscillating micromechanical sensors, such as yaw rate sensors for example, normally use comb-type structures to cause the sensor to oscillate. This excitation takes place for the most part in resonance, in order to utilize the high performance of the system.

The comb-type structures are made up of a stationary element and a mobile element which is attached to the seismic mass to be moved. A voltage is applied between the two comb elements for exciting the oscillation, so that, due to the electrostatic force generated thereby, an attraction is taking place and the two combs are drawn into one another. A movement in the opposite direction is triggered by switching to a second pair of combs.

Because the sensitivity of the sensors is directly proportional to the amplitude of the oscillation generated in this way, the oscillation must be maintained as constant as possible, thereby also ensuring a constant sensitivity. Additional comb structures or pairs of combs are generally used for this purpose. They measure the amplitude of the oscillation via the change in their capacitance which is influenced by the immersion depth. Using this information, a constant amplitude of the oscillation may be ensured via a closed control loop.

### SUMMARY OF THE INVENTION

The present invention is directed to a sensor having at least one actuation/detection means, an actuation unit, and an analyzing unit. The core of the present invention lies in the fact that, in a first operating state, the actuation/detection means is connected to the actuation unit and, in a second operating state, the actuation/detection means is connected to the analyzing unit.

It is advantageous here that the combined actuation/detection means is able to perform a double function by being connected either to the actuation unit or the analyzing unit and thus having to be provided on the sensor only half as many times than is the case in the single function of at least one actuation/detection means for the actuation and at least one actuation/detection means for the analysis previously implemented in the related art.

It is advantageous that the sensor has a seismic mass actively excitable to oscillate. Actuation and detection may be advantageously combined on such a mass since they use the same interaction. Via the actuation/detection means, an actuator exerts a force which results in an acceleration and deflection of the mass. The action of an external force on the seismic mass also results in an acceleration and deflection of this mass which, via the actuation/detection means, may be measured and analyzed by the analyzing unit.

The actuation/detection means is advantageously connected to the seismic mass.

A particularly advantageous embodiment of the present invention provides that the sensor is a micromechanically designed sensor, a yaw rate sensor in particular. Many micromechanical sensors have an actively deflectable seismic mass. Micromechanical yaw rate sensors in particular have an actively deflectable seismic oscillating mass, the deflection of which is detected due to the Coriolis acceleration.

A particularly advantageous embodiment provides that the actuation/detection means represents a capacitor, having a comb-type structure in particular. By utilizing the electrostatic attraction of differently charged capacitor plates, such comb structures may advantageously be used for an actuator. The deflection, in particular the amplitude of the actuator oscillation, may in turn be advantageously and easily determined via the resulting change in capacitance of the comb structure.

A further advantageous embodiment of the component provides that the actuation unit and the analyzing unit are periodically alternately connected to the actuation/detection means. This conforms to the principle of exciting the seismic mass to periodical oscillations and may be advantageously implemented.

It is also advantageous that the actuation unit and the analyzing unit are present in at least one electrical circuit. Electrical circuits together with micromechanical function parts are easily integrated into a sensor. Electrical circuits for the actuation unit and the analyzing unit are particularly advantageous when an electrostatic actuator is used.

The present invention uses one and the same combs for exciting the oscillation as well as for detecting the same. This takes place in that, during a half-period of the oscillation, one half of the combs is used as actuator, while the other half is used for detecting this oscillation. The function assignment is reversed in the second half-period, so that the combs previously used for detection are used as actuator combs and vice versa. The present invention is usable in rotary oscillators as well as in translatory oscillators.

For actuating a resonant oscillator, separate pairs of actuator and detector combs are no longer required, but rather both pairs of combs take on both functions at the same time. This results in the following advantages. Only half as many comb structures are required since each comb structure performs both actuator functions in equal measure. Two bondpads for contacting the sensor may also be omitted. As a result, a more economical use of the chip surface for combs and bondpads is achieved. Alternatively, if the same number of combs is maintained, twice the number of actuator combs is available in a sensor according to the present invention. Alternatively or also combined, this makes two advantageous embodiments of the sensor possible. First of all, the internal pressure (normally a few mbar) in the sensor may be increased since a more forceful actuator may actuate the oscillating mass, even against the resistance of a higher atmospheric pressure. This in turn results in easier processing during capping of the sensors, since the demands on the atmospheric pressure during capping, which is to be held as low as possible, and on the tightness of the cap during subsequent operation would be lower. Secondly, the necessary actuator voltage, which the analyzer chip must supply, may be reduced when more actuators are available. The circuit on the analyzer chip may thus be simplified and minimized, thereby in turn resulting in an economy of surface on the chip which includes the analyzer circuit.

### BRIEF DESCRIPTION OF THE DRAWINGS

FIG. 1 shows the operating principle of a micromechanical yaw rate sensor.

FIG. 2 shows the micromechanical function part of a yaw rate sensor.

FIG. 3 schematically shows the electrical circuit of a yaw rate sensor according to the related art.

FIG. 4 schematically shows the electrical circuit of a yaw rate sensor according to the present invention.

FIG. 5 shows a further design of a yaw rate sensor according to the present invention.

### DETAILED DESCRIPTION

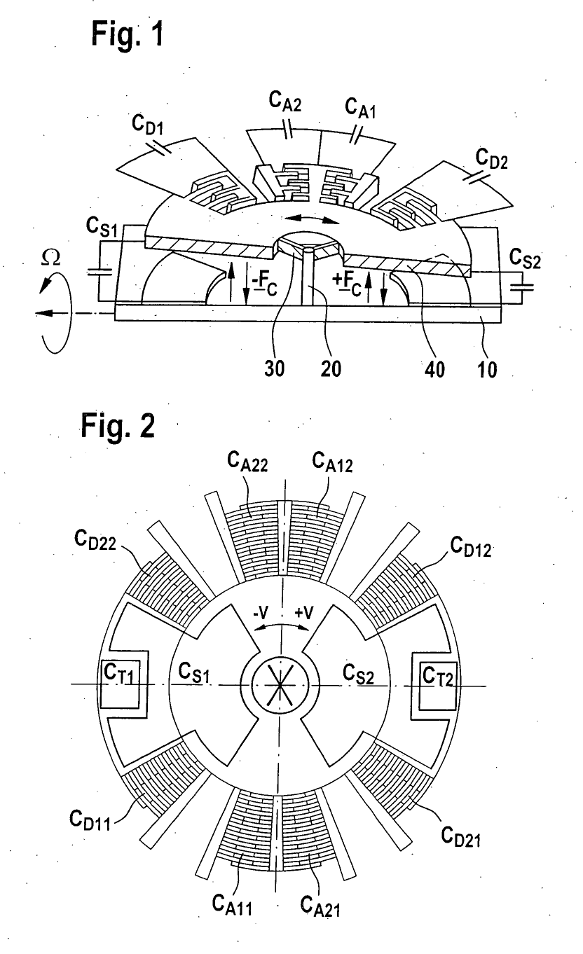

FIG. 1 shows the micromechanical yaw rate sensor according to the related art. The yaw rate sensor is shown in a schematic sectional representation. Represented is a substrate 10, a hub 20 including oscillating springs 30, and an oscillating mass 40. Hub 20 is connected to substrate 10. The hub is also connected to oscillating mass 40 via oscillating springs 30. The yaw rate sensor has comb structures C_{A1}, C_{A2} which are used to induce oscillation V. The actuation of the seismic mass which is excitable to oscillate, oscillating mass 40, takes place in such a way that both combs of an actuator structure, e.g., C_{A1}, represent two electrodes which are charged to different electrical potentials. Due to the electrostatic attraction, the complementary combs are drawn into one another, thereby deflecting oscillating mass 40. Furthermore, the yaw rate sensor has comb structures C_{D1}, C_{D2} which are suitable for detecting the amplitude of the actuator oscillation and whose signal is generally used for regulating this amplitude. Finally, the yaw rate sensor has capacitor structures C_{S1}, C_{S2} which are used to measure the deflection of the oscillating mass due to an acting Coriolis force F_{c}.

During operation of the yaw rate sensor, oscillating mass 40 oscillates on a spherical path V about hub 20. As intended, the yaw rate sensor detects rotations about rotation axis Ω. During such a rotation of the sensor about Ω, Coriolis forces F_{c} occur according to Coriolis's Law, resulting in a deflection of oscillating mass 40 in the direction, marked by arrows, perpendicular to the oscillation plane. The direction of Coriolis forces F_{c} changes in each case with the direction of rotary oscillation V of oscillating mass 40.

FIG. 2 shows in a top view the schematic representation of the micromechanical function part of a yaw rate sensor according to FIG. 1. Represented are actuator combs C_{A11}, C_{A12}, C_{A21}, C_{A22} and detection combs C_{D11}, C_{D12}, C_{D21}, C_{D22}. Actuator combs C_{A11}, C_{A12} are used for actuating oscillating mass 40 in direction +V. Actuator combs C_{A21}, C_{A22} are used for actuating oscillating mass 40 in direction −V. Detection combs C_{D11}, C_{D12}, C_{D21}, C_{D22} are used for measuring the amplitude of actuator deflection in both directions +V and −V. The capacitance of these capacitor-type comb structures C_{D11}, C_{D12}, C_{D21}, C_{D22} depends on the immersion depth of the combs into one another and thus on the overlap surface of the capacitor plates. Electrodes CT1 and CT2 represent test electrodes. A deflection of oscillating mass 40 in the direction of Coriolis forces F_{c} may be achieved by applying a voltage to test electrodes CT1 and CT2. The effect of Coriolis forces F_{c} may thus be simulated and the ability of oscillating mass 40 to deflect may be tested, thereby checking the sensor's functionality.

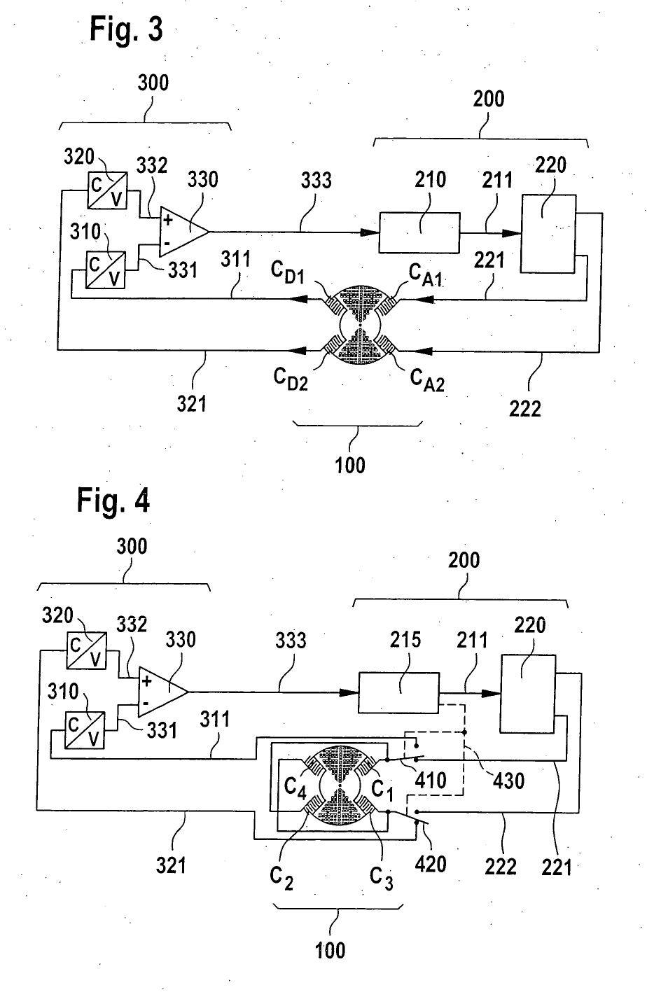

FIG. 3 schematically shows the electrical circuit of a yaw rate sensor according to the related art. A capacitive yaw rate sensor is represented, having a function Part 100 including actuator combs C_{A1} and C_{A2} for actuating a rotary oscillation, as well as detection combs C_{D1} and C_{D2} for detecting the amplitude of the actuator deflection. The yaw rate sensor has an analyzing unit 300 including two capacitance-voltage transformers (C/V transformer) 310 and 320 and a difference amplifier 330. Moreover, the yaw rate sensor also has an actuator 200 including a phase and amplitude regulator 210 and an actuation unit 220.

Separate combs or pairs of combs for actuation (C_{A1}, C_{A2}) and actuation detection (C_{D1}, C_{D2}) are generally used in operation of a resonant sensor according to the example described in FIG. 1 and FIG. 2. During a first half-period of the oscillation, an actuator voltage U_{A} is made available at output 221 by actuation unit 220. Actuator voltage U_{A} is applied between oscillating mass 40 and comb C_{A1} shown in FIG. 3, oscillating mass 40 being thus deflected in direction +V due to the electrostatic attraction. The comb structures immerse into one another, thereby also changing the immersion depth of detection combs C_{D1} and C_{D2}. While the stationary part of comb structure C_{D2} and the corresponding counterpart of oscillator 40 immerse into one another, thereby forming a greater capacitance, comb structure C_{D1} is drawn apart, thereby forming a smaller capacitance. These capacitance changes are detected and supplied in the form of essentially capacitance-proportional signals 311 and 321 to analyzing unit 300. Signal 311 is supplied to capacitance-voltage transformer (C/V transformer) 310 and signal 321 is supplied to capacitance-voltage transformer (C/V transformer) 320. The respective capacitance-proportional signal is transformed into a voltage signal in these C/V transformers. Voltage signal 331 from C/V transformer 310 and voltage signal 332 from C/V transformer 320 are supplied to difference amplifier 330 which generates a control signal 333 for actuator 200 therefrom. Control signal 333 is supplied to phase and amplitude regulator 210. Phase and amplitude regulator 210 generates an actuator control signal 211 containing phase and amplitude information which is supplied to actuation unit 220. Based on actuator control signal 211, actuation unit 220 makes a suitable actuator voltage 221 available at an output. Comb C_{A2} has no function during this time.

During a second half-period of the oscillation, an actuator voltage U_{A} is made available at output 222 by actuation unit 220. Actuator voltage U_{A} is applied between oscillating mass 40 and comb C_{A2} shown in FIG. 3, oscillating mass 40 being thus deflected in direction −V due to the electrostatic attraction. The comb structures immerse into one another, thereby also changing the immersion depth of detection combs C_{D1} and C_{D2}. While the stationary part of comb structure C_{D1} and the corresponding counterpart of oscillator 40 immerse into one another, thereby forming a greater capacitance, comb structure C_{D2} is drawn apart, thereby forming a smaller capacitance. These capacitance changes are detected and supplied in the form of essentially capacitance-proportional signals 311 and 321 to analyzing unit 300. The analysis takes place again in the above-described manner. Comb C_{A1} has no function during this time.

FIG. 4 schematically shows the electrical circuit of a sensor according to the present invention by way of an example of a yaw rate sensor. A capacitive yaw rate sensor is represented having a micromechanical function part 100 including actuation/detection means in the form of capacitor comb structures Cₙ, where n=1, 2, 3, or 4 in this example. Capacitor structures C1 and C2, as well as C3 and C4 are connected in parallel and may, according to the present invention, also be implemented in a single shared structure. In addition, the yaw rate sensor has an analyzing unit 300 including two capacitance-voltage transformers (C/V transformer) 310 and 320, as well as a difference amplifier 330. Moreover, the yaw rate sensor also has an actuator 200 including a modified actuation regulator 215 and an . actuation unit 220. Modified actuation regulator 215 includes a phase and amplitude regulator and a control for two switching elements 410 and 420.

In a first operating state, which corresponds to a first half-period in this example, capacitor structures C1 and C2 are connected to actuation unit 220 via switching element 410 and the signal line carrying voltage signal 221 and actuate oscillating mass 40 in direction +V. Comb structures C1 and C2 mesh in the process; they are thus drawn into one another due to the electrostatic attraction. At the same time, comb structures C3 and C4 are drawn apart. The capacitance change which occurs is measured. Via switching element 420, comb structures C3 and C4 are connected to C/V transformer 320 to which signal 321 is supplied. A capacitance-proportional signal 311 is not applied, because the particular signal line is open at switching element 410. For this reason, C/V transformer 310 does not provide any contribution. Voltage signal 331 (which does not contain any information) from C/V transformer 310 and voltage signal 332 from C/V transformer 320 are supplied to difference amplifier 330 which generates a control signal 333 for actuator 200. Control signal 333 is supplied to modified phase and amplitude regulator 215. Modified phase and amplitude regulator 215 generates an actuator control signal 211 containing phase and amplitude information which is supplied to actuation unit 220. Moreover, a phase-dependent signal 420 for controlling switching elements 410 and 420 is generated. Based on actuator control signal 211, actuation unit 220 makes a suitable actuator voltage 221 available at an output.

In a second operating state, which corresponds to a second half-period in this example, capacitor structures C3 and C4 are connected to actuation unit 220 via switching element 420 and the signal line carrying voltage signal 222 and deflect oscillating mass 40 in direction −V. Comb structures C3 and C4 mesh in the process; they are thus drawn into one another due to the electrostatic attraction. At the same time, comb structures C1 and C2 are drawn apart. The capacitance change which occurs is measured. Via switching element 410, comb structures C1 and C2 are connected to C/V transformer 310 to which signal 311 is supplied. A capacitance-proportional signal 321 is not applied, because the particular signal line is open at switching element 420. For this reason, C/V transformer 320 does not provide any contribution. Voltage signal 331 from C/V transformer 310 and voltage signal 332 (which does not contain any information) from C/V transformer 320 are supplied to difference amplifier 330 which generates a control signal 333 for actuator 200. Control signal 333 is supplied to modified phase and amplitude regulator 215. Modified phase and amplitude regulator 215 generates an actuator control signal 211 having phase and amplitude information which is supplied to actuation unit 220. Moreover, a phase-dependent signal 430 for controlling switching elements 410 and 420 is generated. Based on actuator control signal 211, actuation unit 220 makes a suitable actuator voltage 222 available at an output.

Due to this procedure, twice the number of actuator combs are available in this exemplary embodiment. As mentioned above, capacitor structures C1 and C2 as well as C3 and C4 are connected in parallel. According to the present invention, they may, however, also be implemented in a single shared structure. This makes a consolidation possible, thus reducing the number of comb structures.

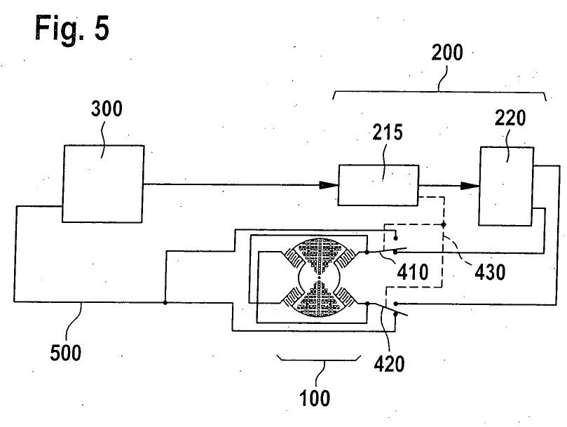

FIG. 5 shows a further embodiment of a yaw rate sensor according to the present invention. A capacitive yaw rate sensor is represented, including a micromechanical function part 100 and an analyzing unit 300. Moreover, the yaw rate sensor also has an actuator 200, including a modified actuation regulator 215 and an actuation unit 220. As described in FIG. 4, depending on the operating state, one of the capacitance signals 321 or 311 is not applied and one of the C/V transformers 320 or 310 is without any function and thus dispensable. In contrast to FIG. 4, comb structures Cₙ are therefore controlled via switching elements 410 and 420 and are alternately connected to analyzing unit 300 via only one shared signal line. Analyzing unit 300 also includes only one C/V transformer instead of the two C/V transformers in the previous exemplary embodiment.

The present invention is explicitly not restricted to the described exemplary embodiments. In addition, further exemplary embodiments are also conceivable. In particular, the actuation/detection means according to the present invention may also be used in linear oscillators, i.e., oscillators having translatory movement instead of rotary movement.

1. A sensor comprising:
at least one actuation/detection device;
an actuation unit; and
an analyzing unit,
wherein the actuation/detection device is connected to the actuation unit in a first operating state, and the actuation/detection device is connected to the analyzing unit in a second operating state.

2. The sensor according to claim 1, further comprising a seismic mass capable of being actively excited to oscillate.

3. The sensor according to claim 2, wherein the actuation/detection device is connected to the seismic mass.

4. The sensor according to claim 1, wherein the sensor is a micromechanical sensor.

5. The sensor according to claim 1, wherein the sensor is a yaw rate sensor.

6. The sensor according to claim 1, wherein the actuation/detection device includes a capacitor having a comb-type structure.

7. The sensor according to claim 1, wherein the actuation unit and the analyzing unit are periodically alternatingly connected to the actuation/detection device.

8. The sensor according to claim 1, wherein the actuation unit and the analyzing unit are contained in at least one electrical circuit.
